(19) United States
(12) Patent Application Publication
(10) Pub. No.: US 2006/0077158 A1
(43) Pub. Date: Apr. 13, 2006

(54) Liquid crystal display device

(75) Inventor: Masakatsu Kitani, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/226,234

(22) Filed: Sep. 15, 2005

(30) Foreign Application Priority Data
Oct. 8, 2004 (JP) 2004-296243

(51) Int. Cl. G09G 3/36

(52) U.S. Cl. 345/88

(57) ABSTRACT

In order to improve display quality, a liquid crystal display device includes a video signal supply line for supplying a video signal to signal lines, and a signal line drive circuit which sequentially turns on analog switches connected between the video signal supply line and each signal line. The video signal supply line is branched into a plurality of lines, and the analog switches are connected to the branched video signal supply lines in a distributed manner. The signal line drive circuit consecutively turns on the analog switches connected to different branched video signal supply lines.

### CROSS-REFERENCE TO RELATED APPLICATIONS

This application is based upon and claims the benefit of priority from Japanese Patent Application No. 2004-296243 filed Oct. 8, 2004; the entire contents of which are incorporated herein by reference.

### BACKGROUND OF THE INVENTION

1. Field of the Invention

The present invention relates to a liquid crystal display device in which display quality is improved by writing the voltage at a video signal supply point to pixels.

2. Description of the Related Art

Liquid crystal display devices in recent years have been used in various instruments such as television receivers, display devices for computers, and mobile phone terminals, and have become necessities.

In a general liquid crystal display device, for example, pixels are respectively placed at intersections where scan lines and signal lines intersect. Further, in the liquid crystal display device, video signals supplied by video signal supply lines are written to the pixels through the signal lines.

Note that such a liquid crystal display device is disclosed in, for example, Japanese Unexamined Patent Publication No. Hei 11-109924.

Such a liquid crystal display device requires that the voltages at video signal supply points on video signal supply lines be written to pixels. However, there are cases where the voltages at the video signal supply points cannot be written to the pixels because of voltage drops in the video signal supply lines.

Moreover, in such a liquid crystal display device, there are cases where the voltage difference between the voltage at the video signal supply point and that (those at pixels) on a signal line varies depending on each signal line. Accordingly, display unevenness may occur in a screen.

### SUMMARY OF THE INVENTION

An object of the present invention is to provide a liquid crystal display device in which display quality is more improved by writing the voltage at a video signal supply point to pixels.

A liquid crystal display device according to an aspect of the present invention includes: a plurality of signal lines; a plurality of scan lines; pixels respectively placed at intersections where the signal lines and the scan lines intersect; a video signal supply line for supplying a video signal to the signal lines; and a signal line drive circuit for sequentially turning on analog switches respectively connected between the video signal supply lines and respective signal lines. The video signal supply line is branched into a plurality of lines, and the analog switches are connected to the branched video signal supply lines in a distributed manner. The signal line drive circuit consecutively turns on the analog switches connected to different branched video signal supply lines.

According to the aspect of the present invention, by branching the video signal supply line and connecting the analog switches to the branched video signal supply lines in a distributed manner, a voltage drop in one branched video signal supply line can be prevented from affecting other branched video signal supply line.

Consecutively turning on analog switches connected to different branched video signal supply lines can prolong the time interval between the turn-on timing of an arbitrary analog switch which is connected to the same video signal supply line and that of the analog switch turned on immediately afterward. That is, an analog switch to be turned on next can be turned on after the voltage drop in the branched video signal supply line has disappeared. Accordingly, the voltage at a video signal supply point can be written to the pixels. As a result, display quality can be improved.

The above-described liquid crystal display device preferably further includes the video signal supply lines respectively corresponding to colors of R, G, and B. For each of the video signal supply lines of the respective colors, the video signal supply line is branched, and the analog switches are connected to each of the branched video signal supply lines in a distributed manner. For each of the video signal supply lines of the respective colors, the signal line drive circuit consecutively turns on the analog switches connected to different branched video signal supply lines.

This makes it possible to write the voltages at the video signal supply points to the pixels corresponding to the respective colors. As a result, the display quality of color display can be improved.

In the aforementioned liquid crystal display device, it is preferable that the video signal supply line is branched into two and that the analog switches are connected to the branched video signal supply lines in a distributed manner. Here, the signal line drive circuit turns on the analog switches connected to one branched video signal supply line, and then turns on the analog switches connected to the other branched video signal supply line.

This makes it possible to write the voltage at the video signal supply point to the pixels. The number of branched video signal supply lines can be minimized.

### BRIEF DESCRIPTION OF THE DRAWINGS

FIG. 1 is a diagram of the configuration of a liquid crystal display device to which one embodiment of the present invention is applied.

FIG. 2 is a circuit diagram illustrating part of a signal line drive circuit.

FIG. 3 is a timing chart for explaining the operation of the signal line drive circuit.

FIG. 4 is a circuit diagram illustrating part of the signal line drive circuit which a related liquid crystal display device includes.

FIG. 5 is a timing chart for explaining the operation of the signal line drive circuit of FIG. 4.

### DESCRIPTION OF THE EMBODIMENT

Hereinafter, one embodiment of the present invention will be described.

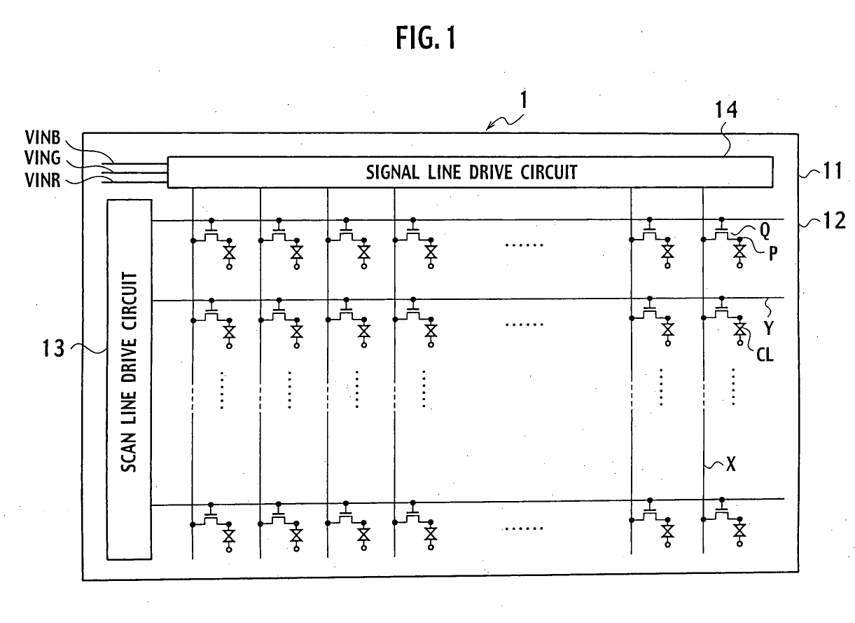

FIG. 1 is a diagram of the configuration of a liquid crystal display device 1 to which the one embodiment of the present invention is applied. The liquid crystal display device 1 includes an array substrate 11 which is made of glass or the like and on which a plurality of signal lines X and a plurality of scan lines Y intersect, and a counter substrate 12 which is made of glass or the like and which faces the array substrate 11 across a liquid crystal layer. Note that the liquid crystal layer is illustrated as liquid crystal cells CL in FIG. 1.

On the array substrate 11, at each intersection where a signal line X and a scan line Y intersect, there are arranged a pixel transistor Q which is turned on by the scan line Y being driven and a pixel electrode P to which a video signal is written from the signal line X through the pixel transistor Q turned on.

The pixel transistor Q is a thin film transistor (TFT) or the like in which poly silicon (p-Si) is used. For example, the gate, source, and drain thereof are connected to the scan line Y, the signal line X, and the pixel electrode P, respectively.

Further, though not illustrated, the counter substrate 12 includes a counter electrode which faces all pixel electrodes P. This counter electrode is supplied with, for example, a constant DC voltage. Further, on the counter substrate 12, red (R), green (G), and blue (B) color filters are regularly arranged, each of which faces each pixel electrode P. Thus, red, green, and blue pixels are constituted, and color display can be performed. Moreover, for such color display, it is assumed that n signal lines are formed on the array substrate 11 for each color.

Further, the liquid crystal display device 1 includes a scan line drive circuit 13 and a signal line drive circuit 14. The scan line drive circuit 13 sequentially drives each scan line Y to turn on the pixel transistors Q connected to the scan line Y. The signal line drive circuit 14 sequentially drives each signal line X within one horizontal scan period in which one scan line Y is being driven.

The number of manufacturing steps can be reduced by forming the scan line drive circuit 13 and the signal line drive circuit 14 on the array substrate 11 in the same process as that for manufacturing the pixel transistors Q. Further, cost can be reduced by reducing the numbers of interconnections and components such as terminals and integrated circuits into which these circuits are integrated.

In the liquid crystal display device 1, a video signal supply line VINR which is supplied with a video signal to be written to the red (R) pixels, a video signal supply line VING which is supplied with a video signal to be written to the green (G) pixels, and a video signal supply line VINB which is supplied with a video signal to be written to the blue (B) pixels are respectively wired to the signal line drive circuit 14.

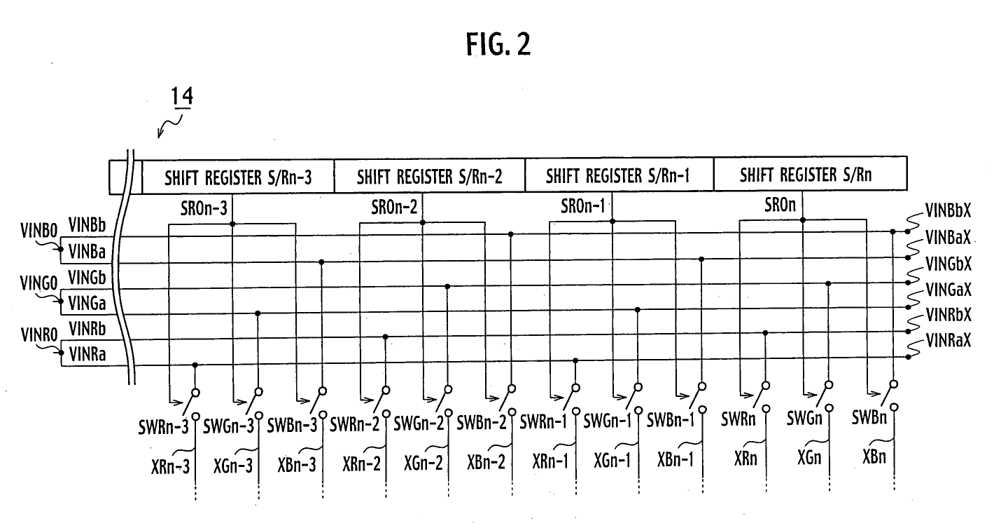

FIG. 2 is a circuit diagram illustrating part of the signal line drive circuit 14. Specifically, a portion is mainly illustrated which drives the four signal lines of each color that are driven last within one horizontal scan period.

The signal line drive circuit 14 includes a shift register S/Rn-3, and analog switches SWRn-3, SWGn-3, and SWBn-3 which respectively correspond to the colors R, G, and B. One terminal of the analog switch SWRn-3 is connected to an upper end portion of a signal line XRn-3 which is driven (n-3)th among the signal lines corresponding to the red (R) pixels.

One terminal of the analog switch SWGn-3 is connected to an upper end portion of a signal line XGn-3 which is driven (n-3)th among the signal lines corresponding to the green (G) pixels. One terminal of the analog switch SWBn-3 is connected to an upper end portion of a signal line XBn-3 which is driven (n-3)th among the signal lines corresponding to the blue (B) pixels.

Further, the signal line drive circuit 14 includes a shift register S/Rn-2, and analog switches SWRn-2, SWGn-2, and SWBn-2. One terminal of the analog switch SWRn-2 is connected to an upper end portion of a signal line XRn-2 which is driven (n-2)th among the signal lines corresponding to the red (R) pixels.

One terminal of the analog switch SWGn-2 is connected to an upper end portion of a signal line XGn-2 which is driven (n-2)th among the signal lines corresponding to the green (G) pixels. One terminal of the analog switch SWBn-2 is connected to an upper end portion of a signal line XBn-2 which is driven (n-2)th among the signal lines corresponding to the blue (B) pixels.

Moreover, the signal line drive circuit 14 includes a shift register S/Rn-1, and analog switches SWRn-1, SWGn-1, and SWBn-1. One terminals of the analog switches SWRn-1, SWGn-1, and SWBn-1 are similarly connected to upper end portions of signal lines XRn-1; XGn-1, and XBn-1 which are driven (n-1)th, respectively.

Furthermore, the signal line drive circuit 14 includes a shift register S/Rn, and analog switches SWRn, SWGn, and SWBn. One terminals of the analog switches SWRn, SWGn, and SWBn are similarly connected to upper end portions of signal lines XRn, XGn, and XBn which are driven n-th, respectively.

In the red (R) video signal supply line VINR wired to the signal line drive circuit 14, a portion thereof illustrated at the left of the drawing is a supply point VINR0 of a red (R) video signal. The video signal supply line VINR branches at the supply point VINR0 into two video signal supply lines VINRa and VINRb, which are wired in the direction of the signal line XBn (upper right in the drawing) in parallel with the scan lines Y and respectively terminated at termination points VINRaX and VINRbX.

Incidentally, in this embodiment, a video signal supply point is assumed to be a point at which a voltage does not fluctuate due to a voltage drop in a video signal supply line or a point at which voltage fluctuation is not large enough to interfere with operation.

Similarly, in the green (G) video signal supply line VING wired to the signal line drive circuit 14, a portion thereof illustrated at the left of the drawing is a supply point VING0 of a green (G) video signal. The video signal supply line VING branches at the supply point VING0 into two video signal supply lines VINGa and VINGb, which are wired in the direction of the signal line XBn (upper right in the drawing) in parallel with the scan lines Y and respectively terminated at termination points VINGaX and VINGbX.

Similarly, in the blue (B) video signal supply line VINB wired to the signal line drive circuit 14, a portion thereof illustrated at the left of the drawing is a supply point VINB0 of a blue (B) video signal. The video signal supply line VINB branches at the supply point VINB0 into two video signal supply lines VINBa and VINBb, which are wired in the direction of the signal line XBn (upper right in the drawing) in parallel with the scan lines Y and respectively terminated at termination points VINBaX and VINBbX.

In the signal line drive circuit 14, the other terminals of the analog switches SWRn-3 and SWRn-1 of the shift registers S/Rn-3 and S/Rn-1 are connected to the video signal supply line VINRa. On the other hand, the other terminals of the analog switches SWRn-2 and SWRn of the shift registers S/Rn-2 and S/Rn are connected to the video signal supply line VINRb.

Similarly, the other terminals of the analog switches SWGn-3 and SWGn-1 are connected to the video signal supply line VINGa. On the other hand, the other terminals of the analog switches SWGn-2 and SWGn are connected to the video signal supply line VINGb.

Similarly, the other terminals of the analog switches SWBn-3 and SWBn-1 are connected to the video signal supply line VINBa. On the other hand, the other terminals of the analog switches SWBn-2 and SWBn are connected to the video signal supply line VINBb.

An output signal SROn-3 of the shift register S/Rn-3 turns on the analog switches SWRn-3, SWGn-3, and SWBn-3.

Similarly, an output signal SROn-2 of the shift register S/Rn-2 turns on the analog switches SWRn-2, SWGn-2, and SWBn-2. Similarly, an output signal SROn-1 of the shift register S/Rn-1 turns on the analog switches SWRn-1, SWGn-1, and SWBn-1. Similarly, an output signal SROn of the shift register S/Rn turns on the analog switches SWRn, SWGn, and SWBn.

Incidentally, an unillustrated portion of the signal line drive circuit 14 is constituted similarly to the illustrated portion, and will not be described here.

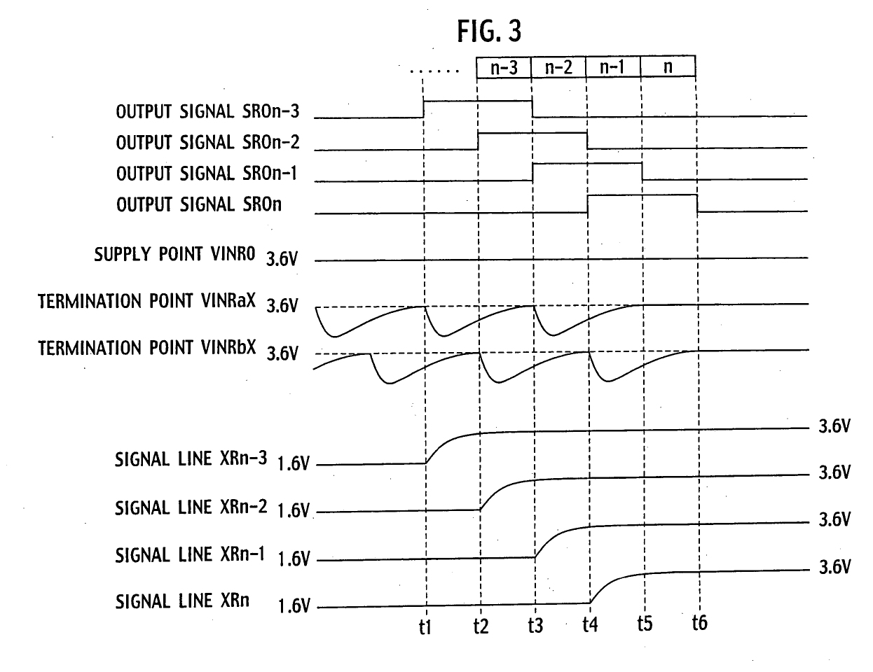

FIG. 3 is a timing chart for the case where the signal line drive circuit 14 performs raster display in an H-line inversion mode in which the polarities of the voltages at horizontally aligned pixels are the same and in a mode in which prewriting is performed on pixels. Note that red (R) pixels are taken as an example in the illustrated timing chart.

As illustrated in FIG. 3, the output signal SROn-3 of the shift register S/Rn-3 allows a current to flow between both terminals of the analog switch SWRn-3 during the time period from time t1 to time t3, which is a time twice a time Δt (write time for one signal line) elapsed after time t1. Thus, the output signal SROn-3 connects the video signal supply line VINRa and the signal line XRn-3.

The output signal SROn-2 of the shift register S/Rn-2 allows a current to flow between both terminals of the analog switch SWRn-2 during the time period from time t2, which is the time Δt elapsed after time t1, to time t4, which is a time twice the time Δt elapsed after time t2. Thus, the output signal SROn-2 connects the video signal supply line VINRb and the signal line XRn-2.

That is, the pixels connected to the signal line XRn-2 are subjected to prewriting using the voltage of a video signal for the pixels connected to the signal line XRn-3 during the time period from time t2 to time t3, and then subjected to writing using the voltage of a video signal for the pixels connected to the signal line XRn-2 during the subsequent time period from time t3 to time t4. Thus, an electric field having an intensity corresponding to the voltage is applied to the liquid crystal cells between the pixel electrodes and the counter electrode, and light corresponding to the intensity of the electric field is emitted from the liquid crystal.

Incidentally, the action performed after the writing of voltages to pixels is also the same for other pixels. Accordingly, a description will be given with a focus on the control of analog switches by shift registers and the voltages on signal lines which change accordingly.

The output signal SROn-1 of the shift register S/Rn-1 allows a current to flow between both terminals of the analog switch SWRn-1 during the time period from time t3, which is the time Δt elapsed after t2, to time t5, which is a time twice the time Δt elapsed after time t3. Thus, the output signal SROn-1 connects the video signal supply line VINRa and the signal line XRn-1.

The output signal SROn of the shift register S/Rn allows a current to flow between both terminals of the analog switch SWRn during the time period from time t4, which is the time Δt elapsed after t3, to time t6, which is a time twice the time Δt elapsed after time t4. Thus, the output signal SROn connects the video signal supply line VINRb and the signal line XRn.

The voltages on the signal lines XRn-3 and XRn-1 before they are connected to the video signal supply line VINRa are assumed to be, for example, 1.6 V. The voltage at the video signal supply point VINR0 is assumed to be, for example, 3.6 V. In this case, the charging of the pixels connected to the signal line XRn-3 is started with the video signal supply line VINRa and the signal line XRn-3 being connected to each other. Thus, a large voltage drop is caused by a large charging current in the video signal supply line VINRa at first. However, the charging current gradually decreases after that. Accordingly, the voltage on the signal line XRn-3 gradually rises.

Here, in the case where the video signal supply line VINRb and the signal line XRn-2 are connected to each other before the charging is finished, a voltage drop caused by a charging current occurs in the video signal supply line VINRb. However, since this voltage drop does not affect the video signal supply line VINRa, the voltage on the signal line XRn-3 continues to rise. The time that a large voltage drop occurs again in the video signal supply line VINRa next is time t3 (time which is the write time Δt for one signal line elapsed after time t2) at which the video signal supply line VINRa and the signal line XRn-1 become conductive with each other. Accordingly, the voltage on the signal line XRn-3 can rise up to a voltage of 3.6 V, which is the voltage at the video signal supply point VINR0.

Incidentally, also from the fact that the voltage at the termination point VINRaX of the video signal supply line VINRa and that at the termination point VINRbX of the video signal supply line VINRb rise up to the voltage at the supply point VINR0 as illustrated in FIG. 3, it is apparent that the voltages at the pixels rise up to the voltage at the supply point VINR0.

On the other hand, the voltages on the signal lines XRn-3 and XRn-1 before they become conductive with the video signal supply line VINRa are assumed to be 3.6 V, and the voltage at the video signal supply point VINR0 is assumed to be 1.6 V. In this case, the voltages at the pixels are decreased to the voltage at the video signal supply point VINR0 by the reverse action. Accordingly, in both cases, the voltage at the video signal supply point VINR0 can be written to the pixels.

Incidentally, the operation concerning the green (G) and blue (B) pixels not illustrated in FIG. 3 and that concerning the pixels connected to unillustrated signal lines are the same as that illustrated in FIG. 3, and therefore will not be described here.

Next, a liquid crystal display device related to the liquid crystal display device 1 of this embodiment will be described.

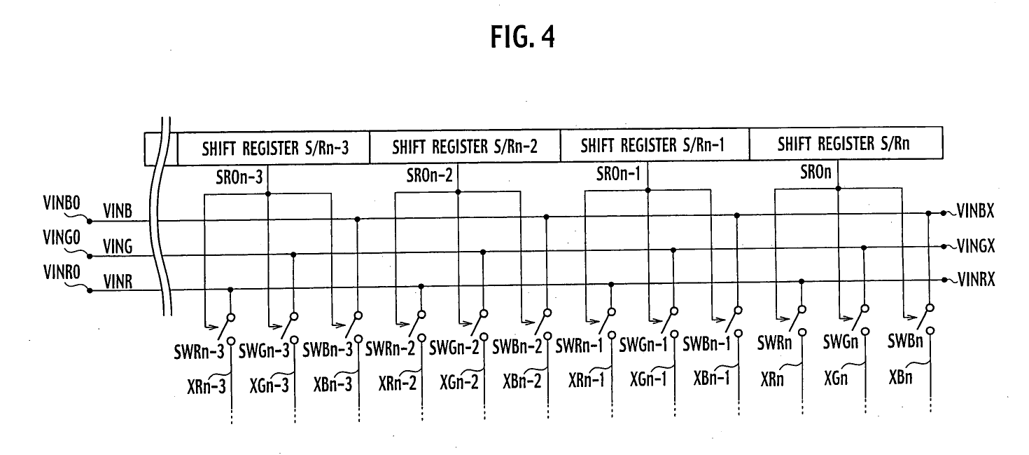

FIG. 4 is a circuit diagram illustrating part of a signal line drive circuit in the related liquid crystal display device which controls analog switches to drive signal lines.

Note that, in the illustrated signal line drive circuit, video signal supply lines VINR, VING, and VINB do not branch, and are wired in the direction of a signal line XBn (upper right in the drawing) in parallel with scan lines and terminated at termination points VINRX, VINGX, and VINBX, respectively.

All of one terminals of analog switches SWRn-3, SWRn-2, SWRn-1, and SWRn are connected to the video signal supply line VINR. Further, all of one terminals of analog switches SWGn-3, SWGn-2, SWGn-1, and SWGn are connected to the video signal supply line VING. Moreover, all of one terminals of analog switches SWBn-3, SWBn-2, SWBn-1, and SWBn are connected to the video signal supply line VINB.

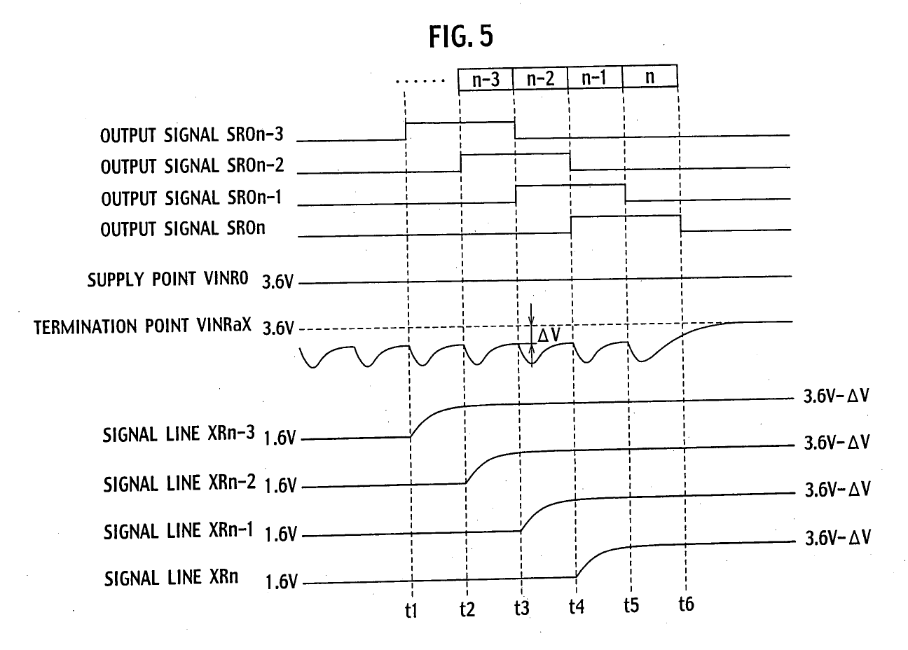

FIG. 5 is a timing chart for the case where the signal line drive circuit of FIG. 4 performs raster display in an H-line inversion mode in which the polarities of the voltages at horizontally aligned pixels are the same and in a mode in which prewriting is performed on pixels. Note that red (R) pixels are taken as an example in the illustrated timing chart.

As illustrated in FIG. 5, an output signal SROn-3 of a shift register S/Rn-3 allows a current to flow through the analog switch SWRn-3 during the time period from time t1 to time t3, which is a time twice a time Δt (write time for one signal line) elapsed after time t1. Thus, the output signal SROn-3 connects the video signal supply line VINR and a signal line XRn-3.

An output signal SROn-2 of a shift register S/Rn-2 allows a current to flow through the analog switch SWRn-2 during the time period from time t2, which is the time Δt elapsed after time t1, to time t4, which is a time twice the time Δt elapsed after time t2. Thus, the output signal SROn-2 connects the video signal supply line VINR and a signal line XRn-2.

That is, the pixels connected to the signal line XRn-2 are subjected to prewriting using the voltage of a video signal for the pixels connected to the signal line XRn-3 during the time period from time t2 to time t3, and then subjected to writing using the voltage of a video signal for the pixels connected to the signal line XRn-2 during the subsequent time period from time t3 to time t4.

Thereafter, the pixels connected to a signal line XRn-1 are subjected to prewriting using the voltage of a video signal for the pixels connected to the signal line XRn-2 during the time period from time t3 to time t4, and then subjected to writing using the voltage of a video signal for the pixels connected to the signal line XRn-1 during the subsequent time period from time t4 to time t5. Incidentally, because of raster display, the voltage of a video signal for the pixels connected to the signal line XRn-3 is equal to that of a video signal for the pixels connected to the signal line XRn-2.

Thereafter, the pixels connected to a signal line XRn are subjected to prewriting using the voltage of a video signal for the pixels connected to the signal line XRn-1 during the time period from time t4 to time t5, and then subjected to writing using the voltage of a video signal for the pixels connected to the signal line XRn during the subsequent time period from time t5 to time t6.

For example, the voltages on the signal lines XRn-3, XRn-2, XRn-1, and XRn before they are connected to the video signal supply line VINR are assumed to be 1.6 V, and the voltage at the video signal supply point VINR0 on the video signal supply line VINR is assumed to be 3.6 V. In this case, the charging of the pixels connected to the signal line XRn-3 is started with the video signal supply line VINR and the signal line XRn-3 being connected to each other. Thus, a large voltage drop is caused by a large charging current in the video signal supply line VINR at first. However, the charging current gradually decreases after that. Accordingly, the voltage on the signal line XRn-3 gradually rises.

However, in the case where the number of signal lines is increased in order to display an image with high definition, the write time Δt for one signal line has to be shortened. Accordingly, if the video signal supply line VINR and the signal line XRn-2 are connected to each other before the charging is finished, the voltage on the signal line XRn-3 cannot rise anymore.

As a result, the voltage (voltages at the pixels connected to the signal line XRn-3) on the signal line XRn-3 becomes a voltage at which it is when the video signal supply line VINR and the signal line XRn-3 are disconnected from each other, i.e., a voltage lower than 3.6 V. Further, the voltage on other signal line and those at the pixels connected to the signal line also become lower than that at the video signal supply point VINR0, similarly.

Also from the fact that the voltage at the termination point VINRX of the video signal supply line VINR becomes lower than that at the supply point VINR0 as illustrated in FIG. 5, it is apparent that the voltages at the pixels become low.

Moreover, there are cases where the voltage difference ΔV between the voltage at the video signal supply point VINR0 and that (voltages at pixels) on a signal line varies depending on each signal line. Accordingly, display unevenness may occur in a screen in a liquid crystal display device including the signal line drive circuit of FIG. 4.

In contrast to this, in the liquid crystal display device of the aforementioned embodiment, for example, the video signal supply line VINR is branched, and the analog switches SWRn-3, SWRn-2, SWRn-1, and SWRn are connected to the branched video signal supply lines VINRa and VINRb in a distributed manner. This can prevent a voltage drop in one branched video signal supply line VINRa from affecting the other video signal supply line VINRb and the like.

In the embodiment, analog switches connected to different branched video signal supply lines are consecutively turned on. For example, the analog switches SWRn-3 and SWRn-2 are consecutively turned on. This makes it possible to double the time interval between the turn-on timing of the analog switch SWRn-3 connected to the video signal supply line VINRa and that of the analog switch SWRn-1, which is turned on immediately afterward. That is, the analog switch SWRn-1 can be turned on after a voltage drop in the video signal supply line VINRa has disappeared. Accordingly, the voltage at the video signal supply point VINR0 can be written to the pixels. As a result, display quality can be improved.

In the embodiment, each of video signal supply lines corresponding to the colors R, G, and B is branched, and analog switches are connected to branched video signal supply lines in a distributed manner. Further, analog switches connected to different branched video signal supply lines are consecutively turned on for each color. Thus, the voltages at the video signal supply points can be written to the pixels corresponding to the respective colors. As a result, the display quality of color display can be improved.

In the embodiment, a video signal supply line is branched into two, and analog switches are connected to the branched video signal supply lines in a distributed manner. After the analog switches connected to one branched video signal supply line are turned on, the analog switches connected to the other branched video signal supply line are turned on. Thus, the voltages at the video signal supply points can be written to the pixels. The number of branched video signal supply lines can be minimized.

Incidentally, the present invention is not limited to the above-described embodiment, but various modifications may be made within the spirit of the present invention. For example, a video signal supply line is branched into three or more, and analog switches are connected to the branched video signal supply lines in a distributed manner as in the above-described embodiment. Further, operation similar to that of the above-described embodiment is performed by consecutively turning on analog switches connected to different branched video signal supply lines.

This makes it possible to eliminate the voltage difference ΔV between the voltage at a video signal supply point and that (those at pixels) on a signal line. Further, the voltage difference between the voltage at a video signal supply point and that on a signal line does not vary depending on each signal line. As a result, display unevenness can be prevented in a screen.

Incidentally, in the aforementioned embodiment, a description has been given by taking as an example the liquid crystal display device 1 which performs color display. However, the present invention may be a liquid crystal display device which performs monochrome display. In the case of a liquid crystal display device which performs monochrome display, one video signal supply line is wired to a signal line drive circuit. In this liquid crystal display device, the one video signal supply line is branched, analog switches are connected to branched video signal supply lines in a distributed manner, and analog switches connected to different branched video signal supply lines are consecutively turned on. This makes it possible to improve the display quality of monochrome display performed by the liquid crystal display device.

What is claimed is:

1. A liquid crystal display device comprising:
a plurality of signal lines;
a plurality of scan lines;
pixels respectively placed at intersections where the signal lines and the scan lines intersect;
a video signal supply line for supplying a video signal to the signal lines; and
a signal line drive circuit for sequentially turning on analog switches respectively connected between the video signal supply line and the signal lines,
wherein the video signal supply line is branched into a plurality of lines, and the analog switches are connected to the branched video signal supply lines in a distributed manner, and
the signal line drive circuit consecutively turns on the analog switches connected to different branched video signal supply lines.

2. The liquid crystal display device according to claim 1, further comprising:
the video signal supply lines respectively corresponding to colors of R, G, and B,
wherein for each of the video signal supply lines of the respective colors, the video signal supply line is branched, and the analog switches are connected to the respective branched video signal supply lines in a distributed manner, and
for each of the video signal supply lines of the respective colors, the signal line drive circuit consecutively turns on the analog switches connected to different branched video signal supply lines.

3. The liquid crystal display device according to claim 1, wherein
the video signal supply line is branched into two, and the analog switches are connected to the respective branched video signal supply lines in a distributed manner, and
the signal line drive circuit turns on the analog switches connected to one branched video signal supply line, and then turns on the analog switches connected to the other branched video signal supply line.
